(19) United States
(12) Patent Application Publication
(10) Pub. No.: US 2004/0032063 A1
(43) Pub. Date: Feb. 19, 2004

(54) Process for shaping plate-shaped materials and an arrangement for carrying out the process

(76) Inventor: Peter Walther, Hille (DE)

Correspondence Address: Adams, Schwartz & Evans, P.A., 2180 Two Wachovia Center, Charlotte, NC, 28282, US

(21) Appl. No.: 10/352,540

(22) Filed: Jan. 28, 2003

(30) Foreign Application Priority Data
Aug. 16, 2002 (DE) 102 38 355.3
Sep. 4, 2002 (DE) 102 40 656.1

(51) Int. Cl. B29C 51/00; B29C 51/10

(52) U.S. Cl. 264/544; 425/387.1; 425/388; 425/389; 264/553; 264/322

(57) ABSTRACT

The invention relates to a process for shaping plate-shaped thermoplastic material into three-dimensional molded bodies with the process steps: insertion of the heated plastic plate to be shaped into a concave mold part, sealing the mold part at its upper edge by covering with a membrane made of a material impermeable to gas and elastically stretchable, pressing the membrane onto the mold edge by means of a rigid covering, and supplying compressed gas to the space between the membrane and the covering, along with an arrangement for carrying out the process.

### TECHNICAL FIELD AND BACKGROUND OF INVENTION

The invention relates to a process for shaping plate-shaped thermoplastic materials, particularly mineral plastic.

Up to now, plastic material has been pressed into a molded body in that it is subjected between two dies made of metal or wood to the pressure of a hydraulic press. This process is expensive because the dies must have a structure which is very stable and an extremely precise surface. Aluminum molds with polished surfaces are used for the most part in this case. Because of the high costs, compression molding is suitable only for large-quantity production such as of washbasins.

Vacuum forming represents the more economical alternative to this press method. In the first method, the plate-shaped material is subjected to a vacuum pressing it into a mold part. The advantage here lies in the easy application, the lower die costs, and thus the potential for more economical production of small lots or individual units. The drawback, however, is that vacuum forming is limited to a relatively low pressure, that is, only atmospheric pressure, on the plate-shaped material. This diminishes its applicability for major amounts of shape-changing or for shaping which requires relatively high degrees of force.

In both processes, the plate-shaped plastic material is brought to a high temperature which can be carried out, for example, by special heating machines.

So-called mineral plastics (e.g., “Coria”a produced by Dupont, and “Carl”a by Valerie & Bosch) have recently come on the market to be used in the manufacture of sanitary items such as bathtubs or shower-tubs, but they are also quite popular in the kitchen area for sinks, wash-stands and the like. These mineral plastics and other comparable plastics are distinguished by their relatively high degree of toughness so that cost-favorable vacuum forming is practically out of the question.

### SUMMARY OF THE INVENTION

The object of the present invention is to provide a process for shaping thermoplastic material which can be used in a simple and cost-favorable way also for plastic materials such as mineral plastics which present a relatively high degree of resistance to shaping.

The invention thus suggests a process for shaping plate-shaped thermoplastic material, particularly mineral plastic, into three-dimensional molded bodies such as bathtubs, sinks, wash-basins, wash-stands, facings and shields, furniture parts, work surfaces, window sills or the like with the following process steps:

Insertion of the heated plastic plate to be shaped into a concave mold part, for example, that of a compression molding die or of a vacuum press;

Sealing the mold part at its upper edge by covering with a membrane made of an impermeable and elastically stretchable material, such as highly heat-resistant silicone rubber;

Pressing the membrane onto the mold edge by means of a rigid, for example, plate-shaped or lid-shaped covering, and

Supplying compressed gas, particularly compressed air, to the space between the membrane and the covering.

The same shaping as carried out with expensive compression molding can be achieved with this kind of process at less die costs (because only one mold part is used). However, it can also be applied for complicated three-dimensional shaping as well as when using mineral plastics and plastics having comparable resistance to shaping. Due to the pressurization of the highly heat-resistant membrane made of silicone rubber or similar elastic material, the plate-shaped material is pressed into the one mold part to assume its inner contour. A further advantage of the invented process is that it can also be carried out with the one mold part of a hydraulic press or the concave mold part of a conventional vacuum press. Operations already having such presses thus do not need to make any large capital investment in order to carry out the invented process. The only thing required is a change in how the process is carried out.

Because of the good sealing of the concave mold part, the shaping process can be improved by using a vacuum pump (already on hand in a vacuum press) to subject the bottom side of the plate material to be shaped to a vacuum while pressure is being applied to its top side.

Particularly good economic efficiency is achieved when the plastic plate is heated before insertion into the mold part to a temperature of 150 to 180° C. depending on the plastic. On the other hand, the mold part should be cooled in order to bring about a rapid cooling of the material, thus achieving a high throughput rate.

The invention also relates to an arrangement for carrying out the process described above. This arrangement consists basically of a concave mold part for receiving the plastic plate to be shaped, a gas-impermeable and elastically stretchable membrane to cover the mold part, means to seal the membrane against the upper edge of the mold part, and means to supply the space between the membrane and the sealing means with a compressed gas.

The arrangement can also be provided with means to generate a vacuum on the side opposite the side of the plastic plate supplied with compressed gas.

In addition, the arrangement can also be connected with means for heating the plastic plate.

Further objects, features, advantages and possible applications of the invention will be seen in the following description of example embodiments using the drawing. All the features described and/or represented by images, alone or in combination, form the object of the invention, either independently of their summary in individual claims or by reference thereto.

### DESCRIPTION OF THE DRAWINGS

FIG. 1 shows a schematic in vertical section of a shaping arrangement embodying the invention for carrying out the process according to the invention, and

FIG. 2 shows another embodiment of the invented shaping arrangement, also in vertical section.

### DESCRIPTION OF THE PREFERRED EMBODIMENT AND BEST MODE

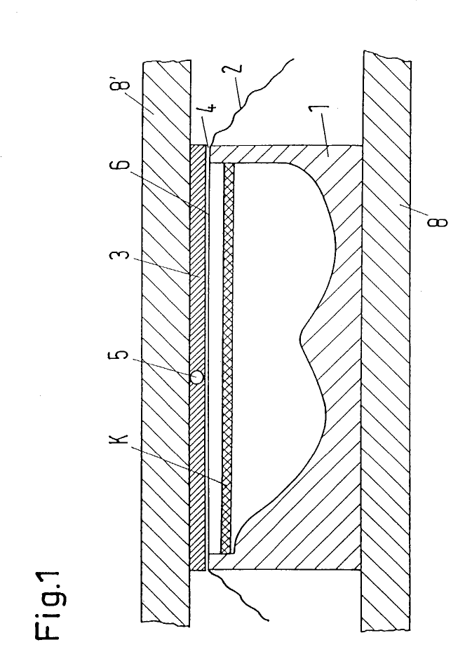

The arrangement represented in FIG. 1 has a mold part 1 with a corresponding concave interior contour which is to be assumed on shaping by a plastic plate 6, here, for example, the indicated shape of a bathtub. It can be the bottom mold part of a hydraulic press or that of a vacuum press.

The plastic plate K is to be inserted from above into the, for example, cooled mold part 1 after being cooled to about 150 to 180° C., for example. A gas-impermeable, elastically stretchable membrane 2, made, for example, of highly heat-resistant silicone rubber, is stretched over the upper edge 4 of the mold part 1, which preferably extends slightly beyond the plastic plate K. Placed on the membrane 2 is a plate 3 which can be pressed on the membrane 2 for reliable edge sealing between a bottom squeezing plate 8 and a top squeezing plate 8′ of a hydraulic press. The plate 3 has a compressed air connection as pressurization means 5 for introducing compressed gas such as compressed air into the space between the plate 3 and the membrane 2. This causes the membrane 2 to come to lie on the top side of the heated plastic plate K and press the latter into the concave interior contour of the mold part 1 until it lies in its entirety against the interior contour. After the molded body produced in this way is cooled, which can be accelerated, for example, by cooling the mold part 1, said molded body can be removed and the arrangement can be used to repeat the process.

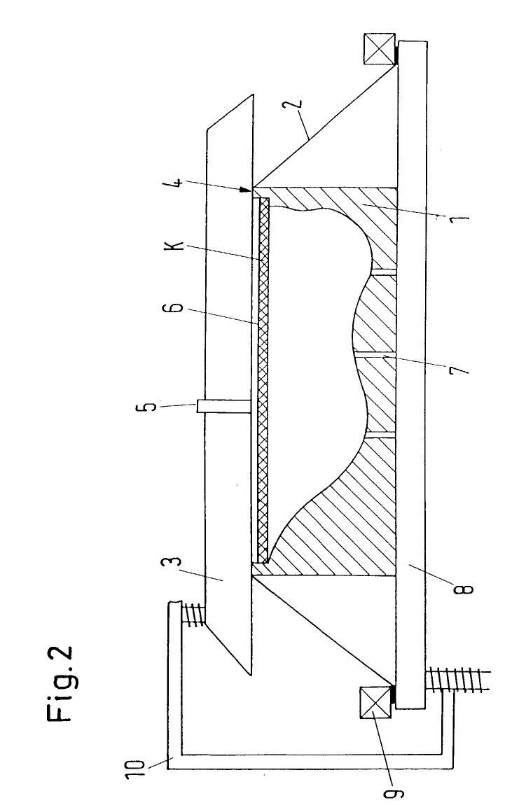

The shaping arrangement shown in FIG. 2 operates in principle in the same way as that shown in FIG. 1. The only essential difference here is that the mold part 1 is provided with a vacuum press with holes 7 used as a means for generating a negative pressure in the concave recess of the mold part 1. Also illustrated here is a special tensioning frame 9 for the elastic membrane 2. Sealing at the upper edge 4 of the mold part 1 with inserted membrane 2 is carried out here with a special cover 3 for which there is a clamping device 10 indicated (on the left-hand side of the drawing), a second such device (not shown) being located on the right-hand side of the mold part 1, for pressing the cover 3 on the edge 4. The cover 3 is also provided with a compressed air connection as pressurization means 5.

Reference symbols

1 Mold part

2 Membrane

3 Sealing means, plate, cover

4 Edge of the mold part

5 Pressurization means, compressed air connection

6 Space

7 Negative pressure generation means, vacuum holes

8 Squeezing plate

9 Tensioning frame

10 Clamping device

K Plastic plate

I claim:

1. Process for shaping plate-shaped thermoplastic material, particularly mineral plastic, into three-dimensional shaped bodies such as bathtubs, sinks, washbasins, wash-stands, facings and shields, furniture parts, work surfaces, window sills or the like with the following process steps:
Insertion of the heated plastic plate to be shaped into a concave mold part, for example, that of a compression molding die or of a vacuum press;
Sealing the mold part at its upper edge by covering with a membrane made of an impermeable and elastically stretchable material, such as heat-resistant silicone rubber;
Pressing the membrane onto the mold edge by means of a rigid, for example, plate-shaped or lid-shaped covering, and
Supplying compressed gas, particularly compressed air, to the space between the membrane and the covering.

2. Process as described in claim 1, characterized by generation of a negative pressure on the side opposite the side of the plastic plate supplied with compressed gas.

3. Process as described in claim 1 or 2 characterized by heating of the plastic plate to a temperature between about 150 and 180 deg C. before insertion into the mold part.

4. Arrangement for carrying out the process as described in one of the foregoing claims with a concave mold part (1) for receiving a plastic plate (K), a gas-impermeable, elastically stretchable membrane (2) stretched over the mold part (1), means (3) for sealing the membrane (2) against the upper edge (4) of the mold part (1), means (6) for supplying the space (7) between the membrane (2) and the sealing means (3) with a compressed gas.

5. Arrangement as described in claim 4 with means (7) for generating a negative pressure on the side of the plastic plate (K) opposite the side supplied with compressed gas.

6. Arrangement as described in claim 4 or 5 with means (7) for heating the plastic plate (K).
